(19) United States
(12) Patent Application Publication
(10) Pub. No.: US 2011/0200386 A1
(43) Pub. Date: Aug. 18, 2011

(54) ROTARY CONNECTOR FOR A ROTATING SHANK OR AXLE

(76) Inventors: Maarten Hartger Kimman, Delft (NL); Jeroen Paul Van Schieveen, Voorburg (NL)

(21) Appl. No.: 13/125,252

(22) PCT Filed: Oct. 23, 2009
(86) PCT No.: PCT/NL2009/050640

§ 371 Date: Apr. 25, 2011

(30) Foreign Application Priority Data
Oct. 23, 2008 (NL) 2002128

(51) Int. Cl. F16B 7/04

(52) U.S. Cl. 403/373

(57) ABSTRACT

Rotary connector for a rotating shank or axle of a machine or similar, having a sleeve body, with an end region having an opening bounded by a circumferentially closed inner-surface for clampingly accommodating said shank or axle. The opening on its circumferential inner-surface is provided with clamping regions for securing the shank or axle with a press fit. A plurality of spokes extend radially outwards from the sleeve body and connect to parts of the sleeve body connecting the clamping regions.

### FIELD OF THE INVENTION

The invention relates to a rotary connector for a rotating shank or axle of a machine or similar, comprising at least one sleeve body, with an end region having an opening bounded by a circumferentially closed inner-surface for clampingly accommodating said shank or axle, which opening on its circumferential inner-surface is provided with clamping regions for securing the shank or axle with a press fit; and wherein there is a plurality of spokes that extend radially outwards from said sleeve body.

A similar rotary connector is known from U.S. Pat. No. 7,217,072. The known rotary connector is intended for accurate clamping of a rotary tool and allows easy mounting and dismounting of such a rotary tool.

A basic embodiment of the known rotary connector has spokes which at their outwardly directed extremities are connected with an outer circumferential casing. By appropriately pressing on this circumferential casing, the spokes are tensioned so as to release the clamping regions from the rotary tool.

U.S. Pat. No. 7,217,072 acknowledges the problem associated with centrifugal forces that occur during rotational operation of the rotary connector or tool holder. These centrifugal forces try to displace the tension spokes in the radially outward direction, as a result of which the accommodating opening would widen radially. This may result in the risk of the press fit on the shank or axle being weakened due to this centrifugal force, and in the worst-case scenario even being lost. A solution for this problem is taught by U.S. Pat. No. 7,217,072 in placing masses at appropriate places in the outer circumferential casing that connects the outwardly extending extremities of the spokes. Thus the centrifugal forces may induce inwardly directed compressive forces to the spokes increasing the press fit when high rotational velocities occur due to the additional masses.

It is an object of the invention to provide an alternative to the known rotary connector which may be applied at very high rotational speeds.

The rotary connector of the invention is to that end characterized by one or more of the appended claims.

In a first aspect of the invention the rotary connector has spokes that connect to parts of the sleeve body connecting the clamping regions, and in that at its radially outer end, each spoke connects to a circumferentially provided individual mass, whereby each individual mass only connects to the sleeve body through said spoke and is free from connections with any other spoke.

By this arrangement the benefit is achieved that the parts of the sleeve body connecting the clamping regions act as levers for converting radially outwards directed forces on the spokes to inwardly directed forces exerted by the clamping regions. With the connector of the invention the further benefit is achieved that it is possible to fit the shank or axle in the connectors' body manually. This is due to the possibility to apply only a moderate initial clamping force when the connector is still at a standstill.

Beneficially there are three clamping regions symmetrically provided along the inner-circumference of said opening. This provides the advantage that even without pre-positioning of the shank or axle the three clamping-regions provide clamping-lines that accurately define the position of the shank or axle to be clamped, as opposed to the known construction of U.S. Pat. No. 7,217,072 which requires very accurate pre-positioning of the shank of axle due to the nearly circular clamping-line of the connector's inner surface that presses the shank or axle.

Particularly when applying high rotational speeds it is advantageous that the connector is rotationally symmetric with respect to a central body axis through the connector's sleeve body.

The rotary connector as discussed above may be coupled with another (similar) rotary connector through an intermediate elastic coupling. This is an effective means to link two shanks or axels to each other that have to perform the same rotational motion.

In a further aspect of the invention it is possible that the rotary connector has two sleeve bodies each having an end region with an opening for accommodating a shank or axle, which sleeve bodies preferably share a common central body axis and have oppositely directed openings. Advantageously the said two sleeve bodies are integrally formed.

A further beneficial arrangement is that a separating slot is provided at the connector's inner surface at least in part separating the neighbouring clamping regions of said oppositely directed openings. This allows to apply different diameters of the axels or shanks that are to be connected to each other.

The invention will hereinafter be further elucidated with reference to an exemplarily embodiment of the rotary connector of the invention and with reference to the drawing.

In the drawing:

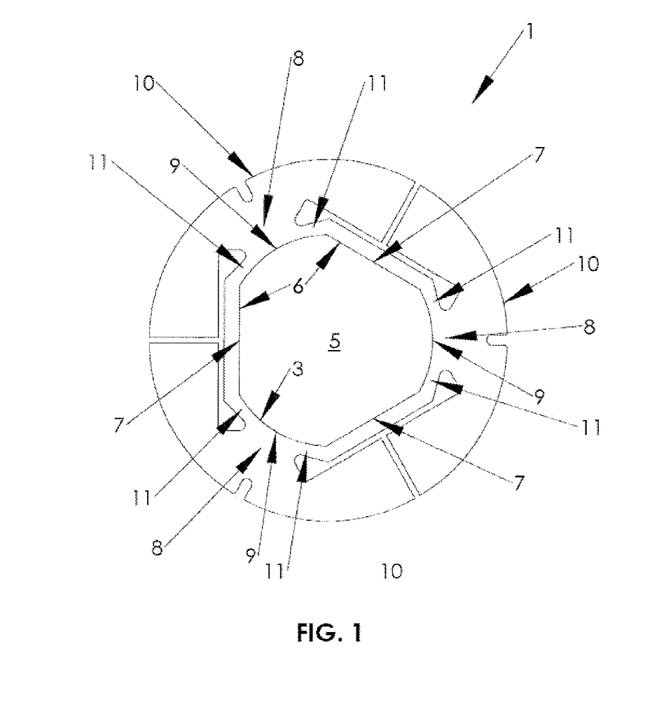

FIG. 1 shows a cross-section of the rotary connector of the invention;

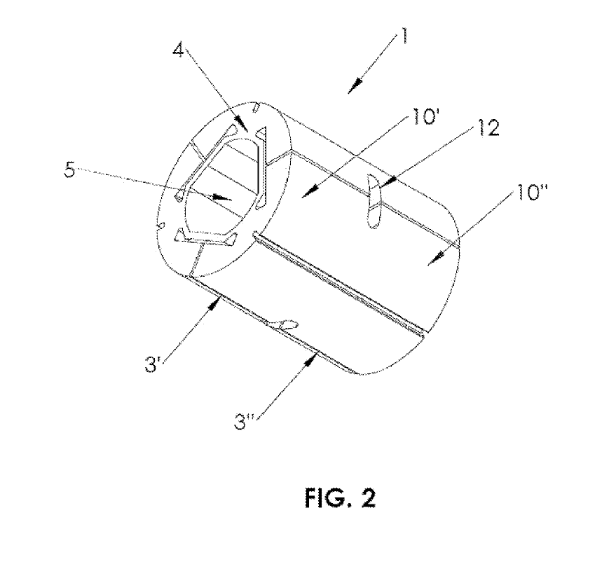

FIG. 2 shows an isometric view of the rotary connector of the invention; and

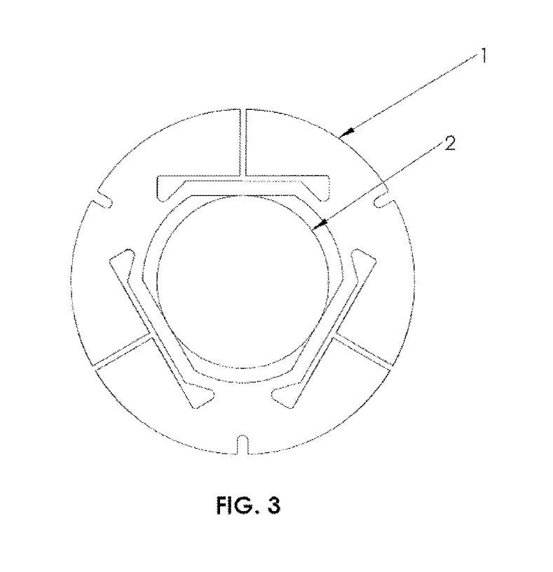

FIG. 3 shows a cross-section of the rotary connector according to FIG. 1 with an axis of a machine connected thereto.

Whenever in the figures the same reference numerals are applied, these refer to the same parts.

With reference first to FIG. 1 and FIG. 3 the rotary connector 1 of the invention is shown for connecting to a rotating shank or an axel 2 (see FIG. 3) of a machine or other device.

The rotary connector 1 comprises at least one sleeve body 3 with an end region 4 as shown in FIG. 2, that is provided with an opening 5. This opening 5 is bounded by a circumferentially closed inner-surface 6 for clampingly accommodating a shank or axel 2, which schematically is shown in FIG. 3.

The opening 5 is on it circumferentially inner-surface 6 provided with clamping regions 7, which are intended for securing the shank or axel 2 with a press fit, particularly at high rotational speeds of the rotary connector 1 and the axel 2, that is connected thereto.

The figures and in particular FIG. 1 further show that there is a plurality of spokes 8, that extend radially outwards from the sleeve body 3. These spokes 8 connect to parts 9 of the sleeve body 3, connecting the clamping regions 7 and at the radially outer end of each spoke 8, said spokes 8 connect to circumferentially provided individual masses 10, whereby each individual mass 10 only connects to the sleeve body 3 through the concerning spoke 8 to which it connects, and is free from any connections with any of the other spokes 8.

The construction as just described in detail with reference to FIG. 1 ensures that the parts 9 of the sleeve body 3 connecting the clamping regions 7 act as levers for converting radially outwards directed forces on these spokes 8 to inwardly directed forces exerted by the clamping regions 7. Said levers are in FIG. 1 particularly itemized with reference no. 11.

As FIG. 1, FIG. 2 and FIG. 3 clearly show there are preferably three clamping regions 7 that are symmetrically provided along the inner circumference of said opening 5.

The figures further clearly show that preferably the connector 1 is rotationally symmetric with respect to an imaginary central body axis through the connector's sleeve body 3.

As one can simply imagine when looking at the rotary connector 1 shown in FIG. 2, this connector 1 may have two sleeve bodies 3′, 3″ each having an end region 4 with an opening 5 for accommodating a shank or axel. The sleeve bodies 3′, 3″ of this rotary connector 1 share a common central body axis and have oppositely directed openings 5. Only one of the openings 5 is visible in FIG. 2.

FIG. 2 further shows that the rotary connector 1 may be provided with a separating slot 12 that is provided in the connector 1 inner surface 6 which serves to at least in part separating the adjacent or neighbouring clamping regions 7 belonging to said oppositely directed openings 5.

I claim:

1. A rotary connector for a rotating shank or axle of a machine, the rotary connector comprising:
at least one sleeve body, with an end region having an opening bounded by a circumferentially closed inner-surface for clampingly accommodating said shank or axle, which opening on its circumferential inner-surface is provided with clamping regions for securing the shank or axle with a press fit; and
a plurality of spokes that extend radially outwards from said sleeve body, wherein the spokes connect to parts of the sleeve body connecting the clamping regions, and in that at its radially outer end, each spoke connects to a circumferentially provided individual mass, wherein each individual mass only connects to the sleeve body through said spoke and is free from connections with any other spoke.

2. The rotary connector according to claim 1, wherein the parts of the sleeve body connecting the clamping regions act as levers for converting radially outwards directed forces on the spokes to inwardly directed forces exerted by the clamping regions.

3. The rotary connector according to claim 1, wherein there are three clamping regions symmetrically provided along the inner-circumference of said opening.

4. The rotary connector according to claim 1, wherein the connector is rotationally symmetric with respect to a central body axis through the connector's sleeve body.

5. The rotary connector according to claim 1, wherein the connector has two sleeve bodies, each having an end region with an opening for accommodating a shank or axle, which sleeve bodies share a common central body axis and have oppositively directed openings.

6. The rotary connector according to claim 5, wherein the two sleeve bodies are integrally formed.

7. The rotary connector according to claim 5, wherein a separating slot is provided at the connector's inner surface at least in part separating the adjacent clamping regions of said oppositely directed openings.
